(19) United States
(12) Patent Application Publication
(10) Pub. No.: US 2002/0132036 A1
(43) Pub. Date: Sep. 19, 2002

(54) Bean curd production methodology

(76) Inventors: Yi-Iong Lee, Taipei City (TW); Hui-Ying Huang, Taipei City (TW)

Correspondence Address: Yi-iong LEE, PO Box 82-144, TAIPEI, TW

(21) Appl. No.: 10/051,111

(22) Filed: Jan. 22, 2002

(30) Foreign Application Priority Data
Jan. 19, 2001 (TW) 090101232

(51) Int. Cl. A23L 1/20

(52) U.S. Cl. 426/634

(57) ABSTRACT

A production methodology of bean curd by adding a O/W type emulsifier solution and coagulant during the process to make the product of bean curd more tender, water containment, resilient, and easier to be fried without wild spillage of cooking oil, and porous interior and stronger binding withstanding long time cooking and fast absorption of broth.

### BACKGROUND OF THE INVENTION

(a) Field of the Invention

The present invention is related to a production methodology of bean curd, and more particularly, to one that involves addition of emulsifier solution and coagulant.

(b) Description of the Prior Art:

As one of the cousins of Chinese food, the bean curd can be cooked with broth, fried, steamed . . . etc. to be served with assorted delicate food. However, the traditional bean curd is not easily get fried, wild spillage of hot oil when being fried, poor interior binding force due to absence of proper emulsification and binding, insufficiency resilience, vulnerable to longer cooking and breaking apart into small pieces and failure of fast absorption of broth flavor.

### SUMMARY OF THE INVENTION

The primary purpose of the present invention is to provide a production methodology of bean curd that is porous and can be easily fried. To achieve the purpose, O/W type emulsifier solution is first added to the soybean milk in the stage of thermal treatment of production process, then after a proper lapse of time, a dedicated coagulant is added for mixing and coagulation before being pressed and formed into the final product. Said emulsifier solution before adding has been well mixed for the air to form air bulb inside the solution and the bulbs stay with the finished product of bean curd. Compared to the conventional bean curd that is added only with dedicated coagulant, the present invention indicates more tender, higher water containment, richer resilience, easier to be fried without wild spillage of cooking oil, pores inside and binding force caused by emulsification and coagulation together allowing longer cooking and fast absorption of broth flavor for the bean curd.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a process flow chart of the present invention;

FIG. 2 is a schematic view of well mixed O/W type emulsifier solution of the present invention; and

FIG. 3 is a schematic view of status of the process of the present invention.

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

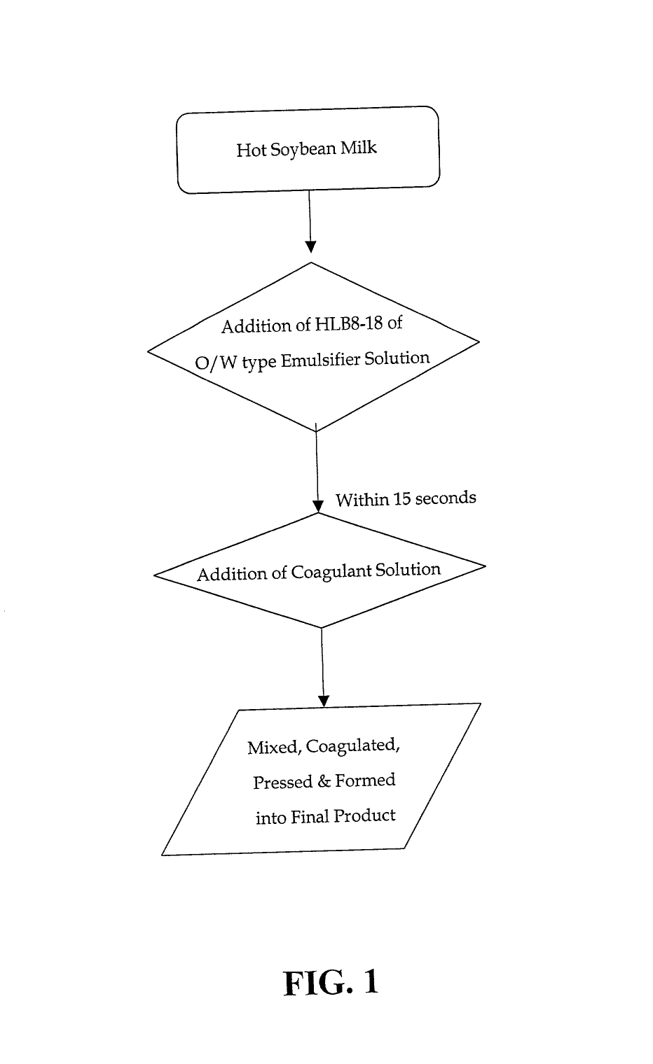

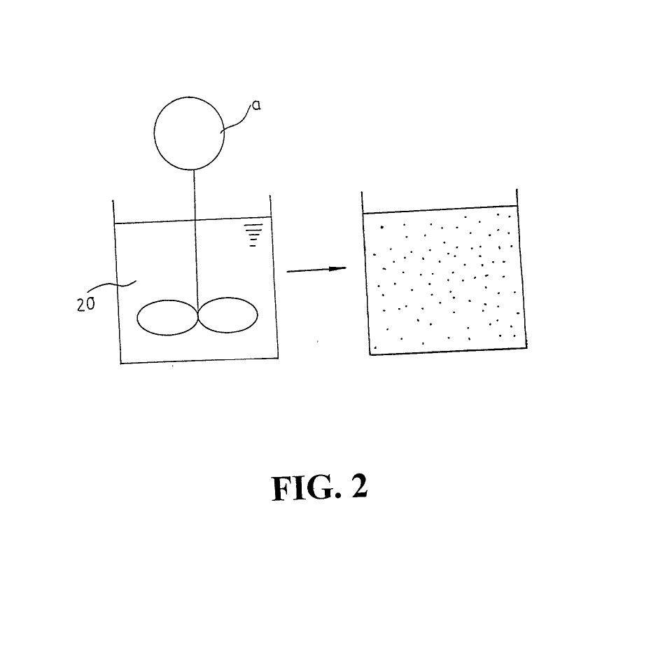

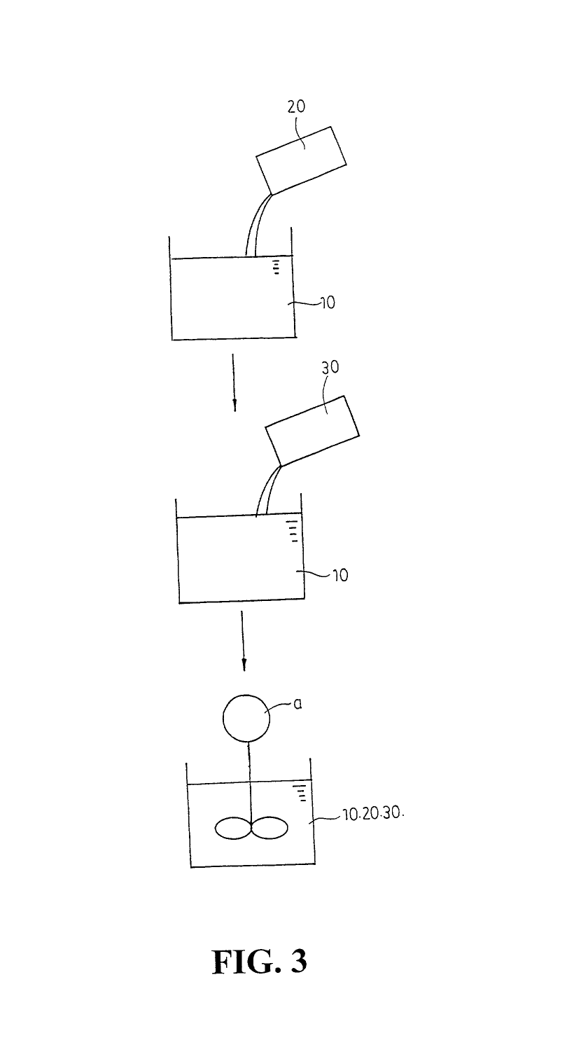

Referring to FIGS. 1 through 3, the present invention comprises the following steps in the hot soybean milk under heat treatment:

(1) An O/W type (emulsion system: oil in water) emulsifier solution 20 is added first. The emulsifier solution 20 relates to an HLB8-18 (Hydrophile-Lipophile Balance) type of O/W emulsifier violently mixed in an emulsification device a for the emulsifier to get dissolved in hot water while bringing air bulbs into the emulsifier solution 20, or alternatively, an air machine is used to pump air into the emulsifier solution 20 under violent mix. In either way, the emulsifier solution is enriched with air bulbs. The preferred addition amount of the emulsifier will be 0.05%˜1.0% (weight by weight) of the soybean milk in a concentration range of8 Brix -16 Brix;

(2) A coagulant solution 30 is added within fifteen (15) seconds after the addition of the emulsifier solution 20, wherein, the coagulant relates to a dedicated coagulant generally available in the market for the production of bean curd; and

(3) The mixing device a is used to well blend the emulsifier solution 20, the coagulant solution 30 and the hot soybean milk 10 completed with thermal treatment for the soybean milk to get coagulated while trapping and fixing those air bulbs in the bean curd, then pressed and formed into a finished product of the bean curd.

The designation of the emulsifier used in the present invention is known as sugar ester. Altematively, stearic acid sugar ester, fatty acid sugar ester, palmitic acid sugar ester, cinnamic acid sugar ester, etc. can be used in the present invention.

The coagulant used in the present invention may be in any of the following items:GDL (Glucono-delta-lactone), MgC₂ (Magnesium chloride), CaSO₄.2H₂O (Calcium Sulfate), MgSO₄ (Magnesium Sulfate), calcium gluconate, CaCO₃ (Calcium Carbonate), NaHCO₃ (Sodium bicarbonate), Na₂CO₃ (Sodium Carbonate), edible plaster powder, saline liquor, or recombined phosphate.

Taking the soybean milk (10 Brix) 1400 ml for instance:

Let the mass of the soybean milk be 1400 g, then

The weight of the emulsifier=1400 g×(0.05%˜1.0%)=0.7 g˜1.4 g

The concentration of the emulsifier solution is:

By dissolving the emulsifier in 100 ml˜120 ml of hot water

The concentration is

| | |
|---|---|
| 0.7 g | 14 g |
| 100 ml | 120 ml |

= 7 g/l˜117 g/l

The mass of the coagulant is:

In the present invention, the mass of the coagulant is 0.3%˜0.4% of the soybean milk so that given with the 1400 g of the soybean milk,

Mass of coagulant=1400 g×0.3%˜0.4%=4.2 g˜5.6 g

The coagulant referred herein relates to one or more than one of coagulants disclosed above, and a compound coagulant is used for the preferred embodiment of the present invention at a concentration of (4.2 g˜5.6 g)/30 ml=140 g/l˜187 g/l.

To sum up, the bean curd produced by the methodology disclosed in the present invention offers at least the following advantages:

(1) high water containment (approximately 88%),

(2) tender, strong binding force and rich in resilience,

(3) easy to be fried without wild spillage of cooking oil,

(4) porous, withstanding longer time cooking, and fast absorption of broth flavor, and

(5) less cooking oil required due to the lesser degree of spillage.

In field experiment, the present invention is proved to achieve its primary purpose. Further, the addition of the emulsifier solution in the present invention also warrants retaining of water containment in the bean curd and improved binding force inside the bean curd to prevent waste of cooking oil, wild spillage of cooking oil, and more delicious appearance of the fried bean curd.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A bean curd production methodology, characterized by addition first an emulsifier solution into the hot soybean milk under thermal treatment before another addition of a coagulant solution at a certain lapse of time, followed with mixing and coagulation to be pressed to form into finished product that is more tender, higher water containment, better resilient, easier to be fried without wild spillage of cooking oil, more pores inside and stronger binding caused by emulsification and coagulation together to withstand longer cooking and faster absorption of broth flavor when compared to the bean curd produced by the conventional method.

2. A bean curd production methodology as claimed in claim 1, wherein, the emulsifier solution relates to HLB8-18 of O/W type emulsifier well mixed at high rpm in a mixing device to get dissolved in hot water while taking air bulbs into the emulsifier solution.

3. A bean curd production methodology as claimed in claim 2, wherein, the addition by weight of the emulsifier is 0.05%˜1.0% also by weight of the soybean milk at a concentration of 8 Brix˜16 Brix after the thermal treatment and before addition of the coagulant solution.

4. A bean curd production methodology as claimed in claim 1, wherein, the coagulant solution is added within fifteen seconds after the addition of the emulsifier solution into the hot soybean milk.
